(19) United States
(12) Patent Application Publication
(10) Pub. No.: US 2014/0082527 A1
(43) Pub. Date: Mar. 20, 2014

(54) METHOD AND DEVICE FOR PROCESSING TABBED-PAGE

(71) Applicant: TENCENT TECHNOLOGY (SHENZHEN) COMPANY LIMITED, Shenzhen (CN)

(72) Inventors: MENG ZHOU, Shenzhen (CN); YUEWEI FAN, Shenzhen (CN); DING XIANG, Shenzhen (CN)

(73) Assignee: TENCENT TECHNOLOGY (SHENZHEN) COMPANY LIMITED, Shenzhen (CN)

(21) Appl. No.: 14/085,288

(22) Filed: Nov. 20, 2013

Related U.S. Application Data
(63) Continuation of application No. PCT/CN2013/080629, filed on Aug. 1, 2013.

(30) Foreign Application Priority Data
Aug. 7, 2012 (CN) 201210278207.6

(51) Int. Cl. G06F 3/0483

(52) U.S. Cl. CPC G06F 3/0483
USPC 715/760

(57) ABSTRACT

Methods and devices for processing a tabbed-page are disclosed. In an exemplary method, when a pinning operation command with respect to a tabbed-page in a browser is received from a user, a first display area can be obtained from a screen of a tabbed-page processing device. A corresponding first UIwebview based on the obtained first display area can be created by the tabbed-page processing device. Content of the tabbed-page can be loaded via the first UIwebview to pin the tabbed-page. Accordingly, an exemplary device for processing a tabbed-page can at least include an area obtaining module and a pinning module.

### CROSS-REFERENCES TO RELATED APPLICATIONS

This application is a continuation of PCT Patent Application No. PCT/CN2013/080629, filed on Aug. 1, 2013, which claims priority to Chinese Patent Application No. CN201210278207.6, filed on Aug. 7, 2012, the entire contents of all of which are incorporated herein by reference.

### FIELD OF THE DISCLOSURE

The present disclosure relates to the field of Internet technology and, more particularly, relates to methods and devices for processing a tabbed-page.

### BACKGROUND

Conventional methods for managing a browsing window, provided by browsers on terminal devices (such as tablet computers and smart phones), are mostly visual-display-type multi-tab-switching window management methods. In the conventional methods for browsing a window, a user can only perform relevant browsing operations with respect to one browsing interface at one time that the user is currently viewing. For example, the conventional methods cannot satisfy user's needs for playing a video in one window and simultaneously browsing a web page in another window and thus is very inconvenient for using.

### BRIEF SUMMARY OF THE DISCLOSURE

According to various embodiments, there is provided a method for processing a tabbed-page. In this method, a first display area can be obtained from a screen of a tabbed-page processing device, when a pinning operation command with respect to a tabbed-page in a browser is received from a user. A corresponding first UIwebview based on the obtained first display area can be created by the tabbed-page processing device. Content of the tabbed-page can be loaded via the first UIwebview to pin the tabbed-page.

According to various embodiments, there is also provided a device for processing a tabbed-page. The device can include an area obtaining module and a pinning module. The area obtaining module can be configured to obtain a first display area from a screen of the device, when a pinning operation command with respect to a tabbed-page in a browser from a user is received. The pinning module can be configured to create a corresponding first UIwebview based on the first display area obtained by the area obtaining module and to load content of the tabbed-page via the first UIwebview to pin the tabbed-page.

According to various embodiments, there is also provided a computer-readable medium having executable computer program. When being executed by a processor, the computer program performs a method for processing a tabbed-page. The method includes obtaining, by a tabbed-page processing device, a first display area from a screen of the tabbed-page processing device, when a pinning operation command with respect to a tabbed-page in a browser is received from a user. The method also includes creating, by the tabbed-page processing device, a corresponding first UIwebview based on the obtained first display area. Further, the method includes loading, by the tabbed-page processing device, content of the tabbed-page via the first UIwebview to pin the tabbed-page.

Other aspects or embodiments of the present disclosure can be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the present disclosure.

FIG. 1 depicts an exemplary method for processing a tabbed-page in accordance with various disclosed embodiments;

FIG. 2 depicts an exemplary pinning process in accordance with various disclosed embodiments;

FIG. 3 depicts another exemplary method for processing a tabbed-page in accordance with various disclosed embodiments;

FIG. 4 depicts a schematic diagram illustrating an exemplary method for processing a tabbed-page in accordance with various disclosed embodiments;

FIG. 5 depicts an exemplary device for processing a tabbed-page in accordance with various disclosed embodiments;

FIG. 6 depicts an exemplary environment incorporating certain disclosed embodiments; and

FIG. 7 depicts an exemplary server consistent with the disclosed embodiments.

### DETAILED DESCRIPTION

Reference will now be made in detail to exemplary embodiments of the disclosure, which are illustrated in the accompanying drawings. Wherever possible, the same reference numbers will be used throughout the drawings to refer to the same or like parts.

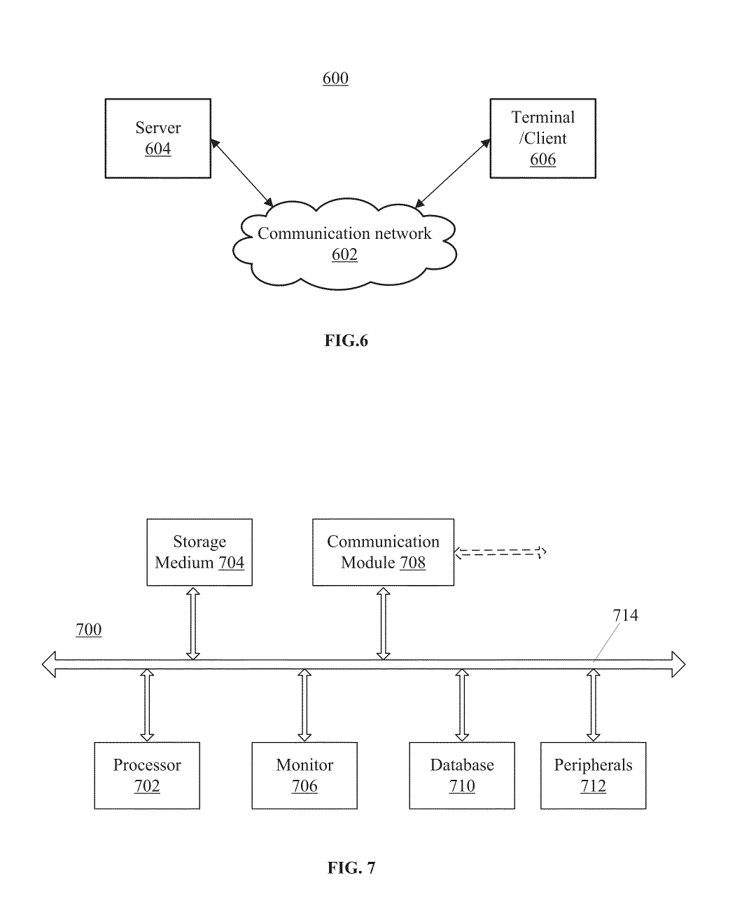

FIGS. 1-5 depict exemplary methods and devices for processing a tabbed-page in accordance with various disclosed embodiments. The exemplary methods and devices can be implemented, for example, in an exemplary environment 600 as shown in FIG. 6.

As shown in FIG. 6, the environment 600 can include a server 604, a terminal 606, and a communication network 602. The server 604 and the terminal 606 may be coupled through the communication network 602 for information exchange, for example, Internet searching, webpage browsing, etc. Although only one terminal 606 and one server 604 are shown in the environment 600, any number of terminals 606 or servers 604 may be included, and other devices may also be included.

The communication network 602 may include any appropriate type of communication network for providing network connections to the server 604 and terminal 606 or among multiple servers 604 or terminals 606. For example, the communication network 602 may include the Internet or other types of computer networks or telecommunication networks, either wired or wireless.

A terminal, as used herein, may refer to any appropriate user terminal device with certain computing capabilities, for example, a personal computer (PC), a work station computer, a notebook computer, a car computer (e.g., carrying in a car or other vehicles), a server computer, a hand-held computing device (a tablet computer), a mobile terminal (a mobile phone, a smart phone, an iPad, an aPad), a POS (i.e., point of sale) device, or any other user-side computing device. In various embodiments, the terms “terminal” and “terminal device” can be used interchangeably. In various embodiments, the terminal 606 can include a multi-window browsing device.

A server, as used herein, may refer one or more server computers configured to provide certain server functionalities, for example, search engines and database management. A server may also include one or more processors to execute computer programs in parallel.

The server 604 and the terminal 606 may be implemented on any appropriate computing platform. FIG. 7 shows a block diagram of an exemplary computing system 700 capable of implementing the server 604 and/or the terminal 606. As shown in FIG. 7, the exemplary computer system 700 may include a processor 702, a storage medium 704, a monitor 706, a communication module 708, a database 710, peripherals 712, and one or more bus 714 to couple the devices together. Certain devices may be omitted and other devices may be included.

The processor 702 can include any appropriate processor or processors. Further, the processor 702 can include multiple cores for multi-thread or parallel processing. The storage medium 704 may include memory modules, for example, ROM, RAM, and flash memory modules, and mass storages, for example, CD-ROM, U-disk, removable hard disk, etc. The storage medium 704 may store computer programs for implementing various processes, when executed by the processor 702.

Further, the peripherals 712 may include I/O devices, for example, keyboard and mouse, and the communication module 708 may include network devices for establishing connections through the communication network 602. The database 710 may include one or more databases for storing certain data and for performing certain operations on the stored data, for example, webpage browsing, database searching, etc.

In operation, the terminal 606 may cause the server 604 to perform certain actions, for example, an Internet search or other database operations. The server 604 may be configured to provide structures and functions for such actions and operations. More particularly, the server 604 may include a data searching system for real-time database searching. In various embodiments, a terminal, for example, a mobile terminal involved in the disclosed methods and systems can include the terminal 606.

FIG. 1 illustrates an exemplary method for processing a tabbed-page in accordance with various disclosed embodiments.

In Step S101, when receiving a pinning operation command with respect to a tabbed-page in a browser from a user, a first display area can be obtained from a screen.

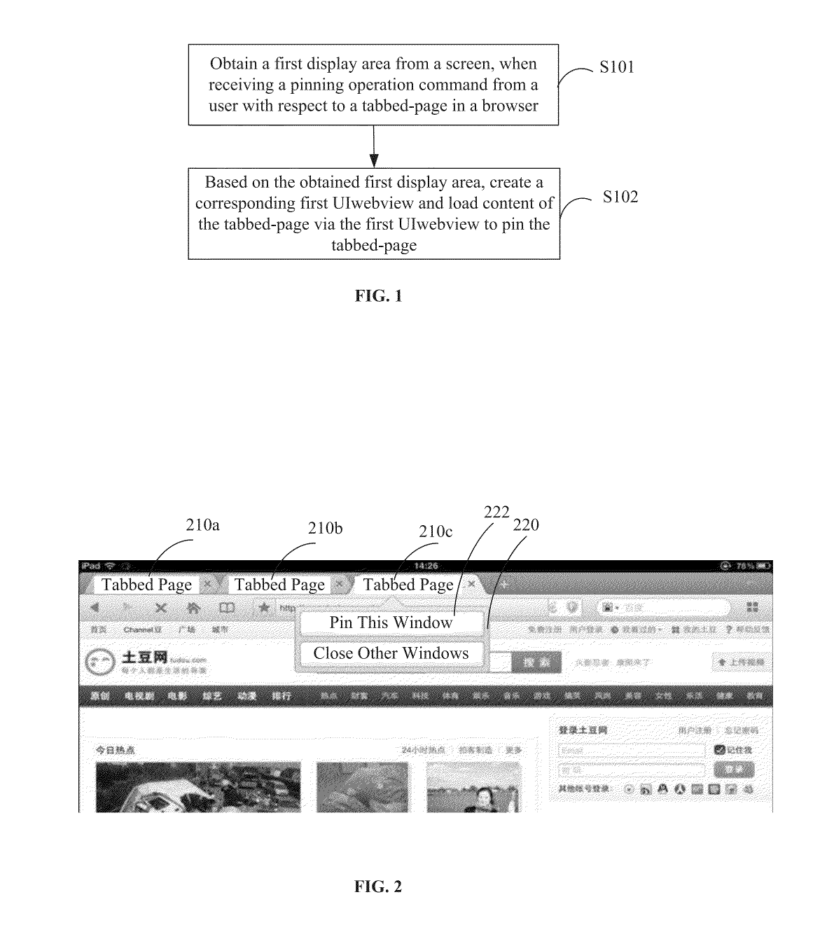

In one embodiment, the pinning operation command can include, but is not limited to, a long pressing (e.g., holding) command. A time length for the long pressing command to last can be greater than one second. For example, when a long-pressing command with respect to a tabbed-page 210c in a browser illustrated in FIG. 2 is received from a user, a selection box 220 can be popped up. When the user selects an item 222 of “pin this window”, a display area (e.g., the first display area) can be obtained from the screen. Specifically, a display area of the screen can be split into two halves. Note that each of the two halves may cover the display area that is greater, less, or the same as the exact half area of the display area. One of the two halves of the display area can be used as the first display area. For example, when the display area of the screen has a size of about 1024×768, an area of about 512×768 on a left or right side of the screen can be used as the first display area. Of course, the user can adjust the size of the first display area according to actual needs.

In Step S102, based on the obtained first display area, a corresponding first UIwebview can be created and content of the tabbed-page can be loaded via the first UIwebview so as to pin the tabbed-page.

As used herein, the UIwebview can be a built-in browser control, and can be used to browse a web page, open a document, and/or operate the like. After the first display area is obtained, the first UIwebview can be created according to the size of the first display area. In practice, the created first UIwebview can be named as a LockUIwebview. Specific creation process of the UIwebview may use known technologies.

After creating the first UIwebview, a kernel of the browser can parse content of the tabbed web page, load the parsed content using the UIwebview and, after the loading, display the content in the first display area to complete the operation of pinning the tabbed-page.

In one embodiment, since the tabbed-page can be pinned, user's operation with respect to other tabbed-pages in the browser cannot affect the pinned tabbed-page. This can satisfy user's needs of simultaneously performing relevant browsing operations in multiple windows.

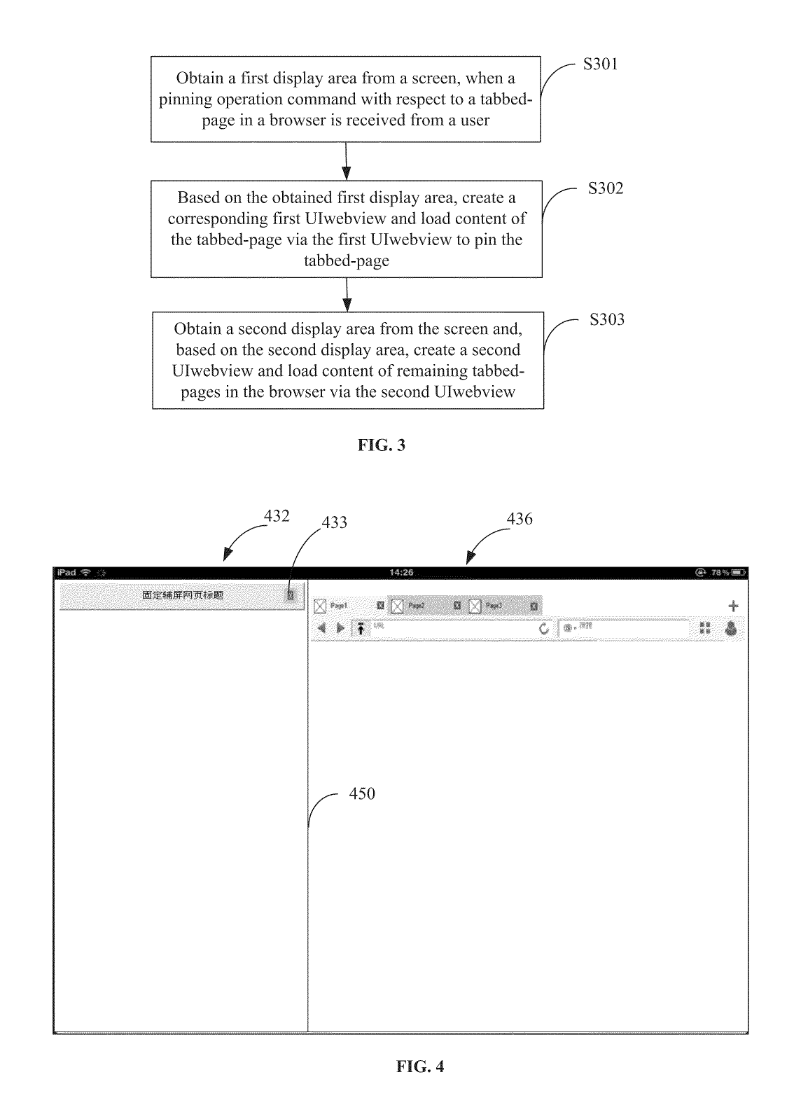

FIG. 3 illustrates another exemplary method for processing a tabbed-page in accordance with various disclosed embodiments.

In Step S301, when a pinning operation command with respect to a tabbed-page in a browser is received from a user, a first display area can be obtained from a screen.

In Step S302, based on the obtained first display area, a corresponding first UIwebview can be created and content of the tabbed-page can be loaded via the first UIwebview so as to pin the tabbed-page. Specific implementation processes of Steps S301 and S302 can be the same as Steps S101 and Step S102 as depicted in FIG. 1.

In Step S303, a second display area can be obtained from the screen and, based on the second display area, a second UIwebview can be created and contents of remaining tabbed-pages in the browser can be loaded via the second UIwebview.

In one embodiment, at the same time when performing Step S302, a display area (e.g., the second display area) can be obtained from the screen to display contents of the remaining tabbed-pages in the browser. Specifically, the second display area can be obtained and, based on the size of the second display area, a UIwebview (e.g., the second UIwebview) can be created and the contents of the remaining tabbed-pages in the browser can be loaded via the second UIwebview. The remaining tabbed-pages are tabbed-pages in the browser excluding the pinned tabbed-page.

In an exemplary embodiment, in order to facilitate a user to simultaneously manage multiple windows, e.g., as shown in FIG. 4, a sum of a first display area 432 and a second display area 436 can cover the entire display area of the screen. For example, sizes of the first display area 432 and the second display area 436 can be adjusted according to user's actual needs. Specifically, when a sliding operation by a user with respect to the first display area 432 and the second display area 436 is detected, a sliding displacement can be recorded and displaying widths of the first display area 432 and the second display area 436 can be adjusted according to the sliding displacement. The sliding operation can include long pressing or pressing and holding an arrow key that is displayed at a border 450 between the first display area 432 and the second display area 436 and dragging the arrow key left or right so as to adjust the displaying widths of the first display area 432 and the second display area 436. For example, as illustrated in FIG. 4, at the border 450 between the first display area 432 and the second display area 436, by long pressing the displayed arrow key and dragging the arrow key left or right, the displaying widths of the first display area 432 and the second display area 436 can be adjusted.

It should be noted that, in order to obtain multiple pinned tabbed-pages, pinning operation can also be performed with respect to the remaining tabbed-pages in the browser. That is, when a pinning operation command with respect to one tabbed-page among the remaining tabbed-pages in the browser is received from a user, a third display area can be obtained. For example, the third display area can be a display area within the second display area. Based on a size of the third display area, a third UIwebview can be created and content of the tabbed-page can be loaded via the third UIwebview. Based on a size of a remaining display area of the second display area, a fourth UIwebview can be created and contents of remaining tabbed-pages in the browser can be loaded via the fourth UIwebview. Sizes of these display areas can be adjusted as needed, and so on, such that multiple pinned tabbed-pages can be obtained.

In various embodiments, in order to enhance usability and to improve user experience, the method depicted herein can further include the following step: obtaining a third display area and, based on the third display area, creating a third UIwebview and loading contents of tabbed-pages currently displayed in the browser via the third UIwebview, when an operation command for unpinning a pinned tabbed-page from a user is received.

For example, as illustrated in FIG. 4, the operation command for unpinning the pinned tabbed-page (e.g., referring to 432) from the user is received. When it is received that a user has clicked a close button 433 (an “X” button 433 on an upper right corner) of the pinned tabbed-page, the method can include exiting from the auxiliary screen browsing mode; re-obtaining a display area; creating a UIwebview based on a size of the obtained display area; and loading contents of tabbed-pages currently displayed in the browser via the created UIwebview. It should be noted that, when there are multiple pinned tabbed-pages, the contents of the tabbed-pages loaded via the created UIwebview do not include contents of other pinned tabbed-pages.

In a case as illustrated in FIG. 2 where there are multiple tabbed-pages 210 a, 210b, 210c shown in a browser, when a command from a user that is generated by long pressing a tabbed-page is received, a selection box 220 can be popped up. When it is received that the user has selected a “pin this window” item 222, a display area having a size of about 300×768 can be obtained on a left side of the screen. Based on the size of this display area, a LockUIwebview (e.g., the first UIwebview) can be created. Content of the tabbed-page can be loaded via the created LockUIwebview and displayed in the display area of about 300×768, and the pinning operation with respect to the tabbed-page can be completed. A remaining display area having a size of 724×768 of the screen (e.g., the screen has a display area of 1024×768) can be obtained. Based on the size of this display area, one more UIwebview can be created and contents of remaining tabbed-pages in the browser can be loaded via this UIwebview. Browsing operations (including, e.g., switching, closing, creating a new tabbed-page, and/or the like) by a user with respect to the tabbed-pages in the display area of about 724×768 do not affect the tabbed-page in the display area of about 300×768. When an operation command from the user is received to unpin the pinned tabbed-page, that is, to close the display area of about 300×768 and exit from the auxiliary screen browsing mode, the display area (1024×768) of the screen can be re-obtained. Based on the size of the obtained display area, a UIwebview can be created. Contents of currently displayed tabbed-pages in the browser can be loaded via the created UIwebview. That is, the browsing mode before the operation of pinning the tabbed-page can be restored.

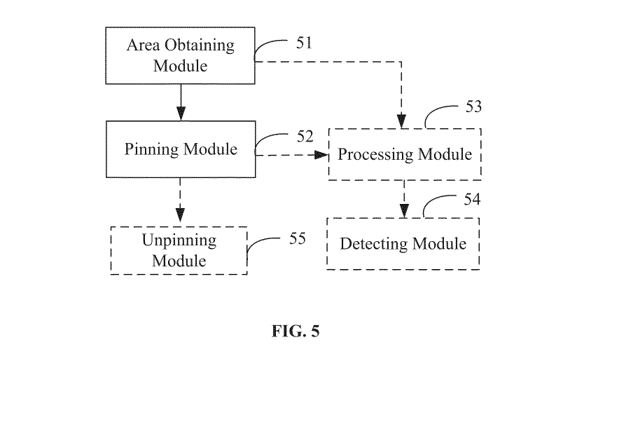

FIG. 5 illustrates an exemplary device for processing a tabbed-page in accordance with various disclosed embodiments. For example, the tabbed-page processing device can be a software module, a hardware module, or a module of a combination of software and hardware that can be operated in a terminal device (e.g., mobile phones and tablet computers as disclosed herein). Alternatively, the exemplary tabbed-page processing device can also be used as an independent application integrated into an application system of the terminal device.

For example, the tabbed-page processing device can include an area obtaining module 51, and a pinning module 52.

The area obtaining module 51 can be used to obtain a first display area when a pinning operation command with respect to a tabbed-page in a browser from a user is received.

The pinning module 52 can be used to create a corresponding first UIwebview based on the first display area obtained by the area obtaining module 51 and load content of the tabbed-page via the first UIwebview so as to pin the tabbed-page.

Further, the device can also include a processing module 53. The processing module 53 can be used to obtain a second display area from the screen, to create a second UIwebview based on the second display area, and to load contents of remaining tabbed-pages in the browser via the second UIwebview. The remaining tabbed-pages are tabbed-pages in the browser excluding the pinned tabbed-page. In an exemplary embodiment, a sum of the first display area and the second display area can be the display area of the screen.

Further, the exemplary device of FIG. 5 can also include a detecting module 54 that can be used, when a sliding operation by a user with respect to the first display area and the second display area is detected, to record a sliding displacement and to adjust displaying widths of the first display area and the second display area according to the sliding displacement. The sliding operation can include long pressing an arrow key that is displayed at a border between the first display area and the second display area and dragging the arrow key left or right so as to adjust the displaying widths of the first display area and the second display area.

It should be noted that, in order to obtain multiple pinned tabbed-pages, pinning operation can also be performed with respect to the remaining tabbed-pages in the browser. That is, when a pinning operation command with respect to a tabbed-page among the remaining tabbed-pages in the browser is received from a user, a third display area can be obtained. The third display area can be a display area within the second display area. Based on a size of the third display area, a third UIwebview can be created and content of the tabbed-page can be loaded via the third UIwebview. Based on a size of a remaining display area of the second display area, a fourth UIwebview can be created and contents of remaining tabbed-pages in the browser can be loaded via the fourth UIwebview. Sizes of these display areas can be adjusted as needed, and so on, such that multiple pinned tabbed-pages can be obtained.

Further, the device in FIG. 5 can also include an unpinning module 55. The unpinning module 55 can be used, when an operation command for unpinning a pinned tabbed-page is received from a user, to obtain a third display area, to create a third UIwebview based on the third display area, and to load contents of tabbed-pages currently displayed in the browser via the third UIwebview.

In an exemplary embodiment, the pinning operation command can include a long pressing command. A time length/period that the long-pressing command lasts can be greater than one second.

The tabbed-page processing device provided herein can be used in the above-described corresponding tabbed-page processing method as depicted in FIGS. 1-4 and can refer to relevant descriptions of the tabbed-page processing method for details.

A person of ordinary skill in the art can understand that the modules included in FIG. 5 are divided according to functional logic, but are not limited to the above divisions as long as the modules can implement corresponding functions. Further, the specific name of each functional module is used for distinguishing from on another without limiting the protection scope of the present disclosure.

In this manner, when a pinning operation command with respect to a tabbed-page in the browser from a user is received, a first display area can be obtained from the screen. Based on the obtained first display area, a corresponding first UIwebview can be created and content of the tabbed-page can be loaded via the first UIwebview so as to pin the tabbed-page. The UIwebview created herein is different from a UIwebview opened by the browser and an area displayed by the UIwebview created herein is also different from an area displayed by the UIwebview opened by the browser. Therefore, a browsing operation by a user with respect to other tabbed-pages in the browser cannot affect the pinned tabbed-page. This allows multiple pinned tabbed-pages to be obtained and thus can satisfy user's needs of simultaneously performing relevant browsing operations in multiple windows including, for example, playing a video in one window and simultaneously browsing a web page in another window. The disclosed methods and devices are easy to implement and easy to use.

In various embodiments, the disclosed modules can be configured in one apparatus or configured in multiple apparatus as desired. The modules disclosed herein can be integrated in one module or in multiple modules. Each of the modules disclosed herein can be divided into one or more sub-modules, which can be recombined in any manner.

One of ordinary skill in the art would appreciate that suitable software and/or hardware (e.g., a universal hardware platform) may be included and used in the disclosed methods and systems. For example, the disclosed embodiments can be implemented by hardware only, which alternatively can be implemented by software products only. The software products can be stored in a computer-readable storage medium including, e.g., ROM/RAM, magnetic disk, optical disk, etc. The software products can include suitable commands to enable a terminal device (e.g., including a mobile phone, a personal computer, a server, or a network device, etc.) to implement the disclosed embodiments.

The embodiments disclosed herein are exemplary only. Other applications, advantages, alternations, modifications, or equivalents to the disclosed embodiments are obvious to those skilled in the art and are intended to be encompassed within the scope of the present disclosure.

### INDUSTRIAL APPLICABILITY AND ADVANTAGEOUS EFFECTS

Without limiting the scope of any claim and/or the specification, examples of industrial applicability and certain advantageous effects of the disclosed embodiments are listed for illustrative purposes. Various alternations, modifications, or equivalents to the technical solutions of the disclosed embodiments can be obvious to those skilled in the art and can be included in this disclosure.

Using disclosed methods and devices for processing a tabbed-page, when a pinning operation command with respect to a tabbed-page in the browser from a user is received, a first display area can be obtained from the screen. Based on the obtained first display area, a corresponding first UIwebview can be created and content of the tabbed-page can be loaded via the first UIwebview so as to pin the tabbed-page. The UIwebview created herein is different from a UIwebview opened by the browser and an area displayed by the UIwebview created herein is also different from an area displayed by the UIwebview opened by the browser. Therefore, a browsing operation by a user with respect to other tabbed-pages in the browser cannot affect the pinned tabbed-page. This allows multiple pinned tabbed-pages to be obtained and thus can satisfy user's needs of simultaneously performing relevant browsing operations in multiple windows including, for example, playing a video in one window and simultaneously browsing a web page in another window. The disclosed methods and devices are easy to implement and easy to use.

What is claimed is:

1. A method for processing a tabbed-page comprising:
obtaining, by a tabbed-page processing device, a first display area from a screen of the tabbed-page processing device, when a pinning operation command with respect to a tabbed-page in a browser is received from a user;
creating, by the tabbed-page processing device, a corresponding first UIwebview based on the obtained first display area; and
loading, by the tabbed-page processing device, content of the tabbed-page via the first UIwebview to pin the tabbed-page.

2. The method of claim 1, further comprising:
obtaining a second display area from the screen;
creating a second UIwebview based on the second display area; and
loading content of remaining tabbed-pages in the browser via the second UIwebview, wherein the remaining tabbed-pages are tabbed-pages in the browser other than the pinned tabbed-page.

3. The method of claim 2, wherein a sum of the first display area and the second display area covers a display area of the screen.

4. The method of claim 2, wherein, when a sliding operation by the user with respect to the first display area and the second display area is detected, the method further comprises:
recording a sliding displacement;
adjusting displaying widths of the first display area and the second display area according to the sliding displacement, the sliding operation including long pressing an arrow key that is displayed at a border between the first display area and the second display area; and
dragging the arrow key left or right to adjust the displaying widths of the first display area and the second display area.

5. The method of claim 1, wherein, when an operation command for unpinning a pinned tabbed-page is received from the user, the method further comprises:
obtaining a third display area;
creating a third UIwebview based on the third display area; and
loading content of tabbed-pages currently displayed in the browser via the third UIwebview.

6. The method of claim 1, wherein the pinning operation command comprises a long-pressing command and a time length that the long-pressing command lasts is greater than one second.

7. A device for processing a tabbed-page comprising:
an area obtaining module, configured to obtain a first display area from a screen of the device, when a pinning operation command with respect to a tabbed-page in a browser from a user is received; and
a pinning module, configured to create a corresponding first UIwebview based on the first display area obtained by the area obtaining module and to load content of the tabbed-page via the first UIwebview to pin the tabbed-page.

8. The device of claim 7, further comprising a processing module, configured to obtain a second display area from the screen; to create a second UIwebview based on the second display area; and to load content of remaining tabbed-pages in the browser via the second UIwebview, wherein the remaining tabbed-pages are tabbed-pages in the browser other than the pinned tabbed-page.

9. The device of claim 8, wherein a sum of the first display area and the second display area covers a display area of the screen.

10. The device of claim 8, further comprising a detecting module configured to:
record a sliding displacement;
adjust displaying widths of the first display area and the second display area according to the sliding displacement when a sliding operation by the user with respect to the first display area and the second display area is detected, the sliding operation comprising long pressing an arrow key that is displayed at a border between the first display area and the second display area; and
drag the arrow key left or right to adjust the displaying widths of the first display area and the second display area.

11. The device of claim 7, further comprising an unpinning module configured to obtain a third display area, to create a third UIwebview based on the third display area, and to load content of tabbed-pages currently displayed in the browser via the third UIwebview, when an operation command for unpinning a pinned tabbed-page is received from the user.

12. The device of claim 7, wherein the pinning operation command comprises a long-pressing command and a time length that the long-pressing command lasts is greater than one second.

13. The device of claim 7, wherein the multi-window browsing device comprises a mobile terminal.

14. The device of claim 7, wherein the multi-window browsing device comprises a personal computer, a notebook computer, a car computer, a server computer, a hand-held computing device, and a point of sale (POS) device.

15. A computer-readable medium having executable computer program for, when being executed by a processor, performing a method for processing a tabbed-page, the method comprising:
obtaining, by a tabbed-page processing device, a first display area from a screen of the tabbed-page processing device, when a pinning operation command with respect to a tabbed-page in a browser is received from a user;
creating, by the tabbed-page processing device, a corresponding first UIwebview based on the obtained first display area; and
loading, by the tabbed-page processing device, content of the tabbed-page via the first UIwebview to pin the tabbed-page.

16. The computer-readable medium of claim 15, further comprising:
obtaining a second display area from the screen;
creating a second UIwebview based on the second display area; and
loading content of remaining tabbed-pages in the browser via the second UIwebview, wherein the remaining tabbed-pages are tabbed-pages in the browser other than the pinned tabbed-page.

17. The computer-readable medium of claim 16, wherein a sum of the first display area and the second display area covers a display area of the screen.

18. The computer-readable medium of claim 16, wherein, when a sliding operation by the user with respect to the first display area and the second display area is detected, the method further comprises:
recording a sliding displacement;
adjusting displaying widths of the first display area and the second display area according to the sliding displacement, the sliding operation including long pressing an arrow key that is displayed at a border between the first display area and the second display area; and
dragging the arrow key left or right to adjust the displaying widths of the first display area and the second display area.

19. The computer-readable medium of claim 15, wherein, when an operation command for unpinning a pinned tabbed-page is received from the user, the method further comprises:
obtaining a third display area;
creating a third UIwebview based on the third display area; and
loading content of tabbed-pages currently displayed in the browser via the third UIwebview.

20. The computer-readable medium of claim 15, wherein the pinning operation command comprises a long-pressing command and a time length that the long-pressing command lasts is greater than one second.
